(19) United States
(12) Patent Application Publication
(10) Pub. No.: US 2018/0273675 A1
(43) Pub. Date: Sep. 27, 2018

(54) WATCH BANDS

(71) Applicant: SOLVAY SPECIALTY POLYMERS ITALY S.P.A., Bollate (IT)

(72) Inventors: Antonio RUSSO, Milano (IT); Alberto ZOMPATORI, Milano (IT)

(21) Appl. No.: 15/757,018

(22) PCT Filed: Jul. 7, 2016
(86) PCT No.: PCT/EP2016/066070

§ 371 Date: Mar. 2, 2018

(30) Foreign Application Priority Data
Sep. 3, 2015 (EP) 15183605.3

(51) Int. Cl. C08G 18/50; A44C 5/00; A44C 27/00; C08J 5/00; C08G 18/42; C08G 18/12; C08G 18/32; C08G 18/44; C08G 18/48; C08G 18/73; C08G 18/76; C08G 18/66; C08G 18/22; B29C 39/00; B29C 39/02; B29C 39/38

(52) U.S. Cl. CPC C08G 18/5015; B29K 2075/00; A44C 27/00; C08J 5/00; C08G 18/4277; C08G 18/12; C08G 18/3206; C08G 18/44; C08G 18/4854; C08G 18/73; C08G 18/7671; C08G 18/4202; C08G 18/4238; C08G 18/6674; C08G 18/227; B29C 39/003; B29C 39/02; B29C 39/38; C08J 2375/04; A44C 5/0053

(57) ABSTRACT

The present invention relates to a watch bands made from a fluorinated polyurethane polymer comprising recurring units derived from at least one hydroxy-terminated (per)fluoropolyether polymer.

### CROSS REFERENCE TO RELATED APPLICATIONS

This application claims priority from European application No. 15183605.3 filed on 3 Sep. 2015, the whole content of this application being incorporated herein by reference for all purposes.

### TECHNICAL FIELD

The present invention relates to watch bands made from a fluorinated polyurethane polymer comprising recurring units derived from (per)fluoropolyether polymers.

### BACKGROUND ART

Watch bands made from polymeric materials have been already disclosed in the art. For example, EP 2468127 B (BIWI S. A.) discloses jewelry items made from compositions comprising an elastomeric matrix having dispersed therein reinforcing fillers selected from the group consisting of microfibers, polytetrafluoroethylene nanoparticles, and mixtures thereof, said composite material being obtained from a composition comprising between 60% and 95% by weight of at least one elastomer, from 0% to 5% by weight of microfiber and from 0% to 40% by weight of polytetrafluoroethylene nanoparticles, based on the total weight of the composition, at least one of said reinforcing fillers being present. GB 2460890 A (EVENTUAL LIMITED) discloses a band comprising a protective portion housing an electronic tag and a second portion forming a band to be worn by a person, wherein the band material may be an elastomeric material such as rubber, in particular silicone rubber, and the protective portion may be made of metal or nylon.

Further to the above, wearable devices having at least one component made from or coated with a polyurethane polymer have been disclosed for example in US 2013/0197680 (NIKE INC.), US 2014/0155724 (KONINKLI JKE PHILIPS N. V.), US 2013/0088408 (ELECTRONICS AND TELECOMMUNICATIONS RESEARCH INSTITUTE) and JP H0925405 (NIPPON POLYURETHANE KOGYO KK).

Heat processable elastomeric polyurethanes comprising (per)fluoropolyether blocks were disclosed for example in U.S. Pat. No. 5,332,798 (AUSIMONT S.P.A.).

### SUMMARY OF INVENTION

The Applicant faced the problem of providing new polymeric materials that can be useful for the manufacture of watch bands.

The Applicant has surprisingly found that a polyurethane polymer comprising recurring units derived from (per)fluoropolyether polymers has properties, notably stain, chemical and wear resistance, low temperature flexibility, silky feel and mechanical properties, such that it can be used for the manufacture of watch bands.

In addition, the Applicant has surprisingly found that the watch bands according to the present invention have improved properties, notably with respect to stain, abrasion and chemical resistance, when compared to watch bands obtained from fully hydrogenated polyurethanes.

Thus, in a first aspect, the present invention relates to a watch band made from a composition [composition (C)] comprising at least one fluorinated polyurethane [F-TPU polymer], said F-TPU polymer comprising recurring units derived from:
(a) at least one diol selected from the group comprising poly-ether type diol, poly-ester type diol, polybutadien-diol and polycarbonate-diol;
(b) at least one hydroxy-terminated (per)fluoropolyether polymer [PFPE polymer];
(c) at least one aromatic, aliphatic or cycloaliphatic diisocyanate; and
(d) at least one aliphatic, cycloaliphatic or aromatic diol having from 1 to 14 carbon atoms.

The Applicant has surprisingly found that the watch band made from said composition (C) provides a soft silky feeling to the touch, without the addition of plasticizer agents to said composition (C). This provides an advantage from the toxicological point of view, as the plasticizers can migrate of the surface of the object and from there to the skin of the user, thus resulting in possible problems of reddening of the skin, irritation and allergy.

### DESCRIPTION OF EMBODIMENTS

For the purposes of the present description:
the term “(per)fluoropolyether” is intended to indicate a “fully or partially fluorinated polyether”;
the expression “(per)fluoropolyoxyalkylene chain” is intended to indicate a partially or fully fluorinated, straight or branched, polyoxyalkylene chain;
the use of parentheses before and after symbols or numbers identifying compounds, chemical formulae or parts of formulae has the mere purpose of better distinguishing those symbols or numbers from the rest of the text and hence said parentheses can also be omitted.

Preferably, the F-TPU polymer is a block copolymer, i.e. a polymer comprising blocks (also referred to as “segments”), each block comprising recurring units deriving from monomer (a), monomer (b), monomer (c) or monomer (d), as defined above.

Preferably, said F-TPU polymer has an average number molecular weight of from 30,000 to about 70,000 Da.

Preferably, said F-TPU polymer has a melting point (Tₘ) of from about 120° C. to about 240° C.

Preferably, said at least one monomer (a) has an average number molecular weight of from 500 to 4,000 Da, more preferably of from 1,000 to 4,000.

Preferably, said at least one monomer (a) is selected in the group comprising poly(ethylene)glycol, poly(propylene)glycol, poly(tetramethylen)glycol (PTMG), poly(1,4-butanediol)adipate, poly(ethandiol-1,4-butanedio) adipate, poly(1,6-hexandiol-neopentyl)glycol adipate, poly-caprolactone-diol (PCL) and polycarbonate-diol. Poly(tetramethylen)glycol, polycarbonate-diol and poly-caprolactone-diol being particularly preferred.

Preferably, said at least one monomer (b) is a hydroxy-terminated (per)fluoropolyether polymer [PFPE polymer] comprising a (per)fluoropolyoxyalkylene chain [chain (R_{pf})] having two chain ends, wherein one or both chain ends terminates with at least one —OH group.

Preferably, at least one chain end of said chain (R_{pf}) terminates with a group of formula:

—CH₂(OCH₂CH₂)ₜ—OH (I)

wherein
t is 0 or from 1 to 5.

More preferably, both chain ends of said chain (R_{pf}) terminate with a group of formula (I) as defined above.

Preferably, said chain (R_{pf}) is a chain of formula

—(CFX)ₕO(R_{f})(CFX′)ᵢ—

wherein
h and i, equal or different from each other, are equal to or higher than 1, preferably from 1 to 10, more preferably from 1 to 3;
X and X′, equal or different from each other, are —F or —CF₃, provided that when h and/or i are higher than 1, X and X′ are —F;
(R_{f}) comprises, preferably consists of, repeating units R^{º}, said repeating units being independently selected from the group consisting of:
(i) —CFXO—, wherein X is F or CF₃;
(ii) —CFXCFXO—, wherein X, equal or different at each occurrence, is F or CF₃, with the proviso that at least one of X is —F;
(iii) —CF₂CF₂CW₂O—, wherein each of W, equal or different from each other, are F, Cl, H;
(iv) —CF₂CF₂CF₂CF₂O—;
(v) —(CF₂)ⱼ—CFZ—O— wherein j is an integer from 0 to 3 and Z is a group of general formula —O—R_{(f-a)}-T, wherein R_{(f-a)} is a fluoropolyoxyalkene chain comprising a number of repeating units from 0 to 10, said recurring units being chosen among the following: —CFXO—, —CF₂CFXO—, —CF₂CF₂CF₂O—, —CF₂CF₂CF₂CF₂O—, with each of each of X being independently F or CF₃ and T being a C₁-C₃ perfluoroalkyl group.

More preferably, chain (R_{f}) is selected from the following formulae (R_{f}-a) to (R_{f}-c):

—(CF₂O)ₙ(CF₂CF₂O)ₘ(CF₂CF₂CF₂O)ₚ(CF₂CF₂CF₂CF₂O)_{q}— (R_{f}-a)

wherein m, n, p, q are 0 or integers selected in such a way as chain R_{f} meets the above number average molecular weight requirement, with the proviso that if, p and q are simultaneously 0, n is not 0; when m is other than 0, the m/n ratio is preferably between 0.1 and 20; when (m+n) is other than 0, (p+q)/(m+n) is preferably between 0 and 0.2;

—(CF₂CF(CF₃)O)ₐ(CF₂CF₂O)_{b}(CF₂O)_{c}(CF(CF₃)O)_{d}— (R_{f}-b)

wherein a, b, c, d are 0 or integers selected in such a way as chain R_{f} meets the above number average molecular weight requirement; with the proviso that, at least one of a, c and d is not 0; when b is other than 0, a/b is preferably between 0.1 and 10; when (a+b) is different from 0 (c+d)/(a+b) preferably is between 0.01 and 0.5, more preferably between 0.01 and 0.2;

—(CF₂CF(CF₃)O)ₑ(CF₂O)_{f}(CF(CF₃)O)_{g}— (R_{f}-c)

wherein e, f, g are 0 or integers selected in such a way as chain R_{f} meets the above number average molecular weight requirement; when e is other than 0, (f+g)/e is preferably between 0.01 and 0.5, more preferably between 0.01 and 0.2.

PFPE polymers wherein chain (R_{f}) complies with formula (R_{f}-a) as defined above, wherein p and q are 0, are particularly preferred in the present invention.

In a preferred embodiment, said PFPE polymer complies with the following formula (PFPE-I):

HO—(CH₂CH₂O)ₜ—CH₂—(R_{pf})—CH₂(OCH₂CH₂)ᵤ—OH (PFPE-I)

wherein
t and u are, each independently, 0 or from 1 to 5; and
R_{pf} is as defined above.

Preferably, said PFPE polymer has an average number molecular weight of from 400 to 10,000 Da, more preferably from 1,000 to 5,000.

In a preferred embodiment, the molar ratio between monomers (a) and monomers (b) is from 2 to 20, more preferably from 2 to 10.

In a preferred embodiment, the amount of monomers (b) is such that the F-TPU polymer comprises from 4 to 30 wt. % of fluorine.

Preferably, said at least one monomer (c) has a number molecular weight of 500 Da or lower, preferably from 10 to 500 Da.

Preferably, said at least one monomer (c) is selected in the group comprising, preferably consisting of, 4,4′-methylene-diphenylene-diisocyanate (MDI), 1,6-hexan-diisocyanate (HDI), 2,4-toluene-diisocyanate, 2,6-toluene-diisocyanate, xylilen-diisocyanate, naphthalene-diisocyanate, paraphenylen-diisocyanate, hexamaethylen-diisocyanate, isophorone-diisocyanate, 4,4′-dicyclohexyl-methane-diisocyanate and cyclohexyl-1,4-diisocyanate.

4,4′-methylene-diphenylene-di-isocyanate (MDI), 1,6-hexan-diisocyanate (HDI) and hexamaethylen-diisocyanate being particularly preferred.

Preferably, said at least one monomer (d) is selected in the group comprising, preferably consisting of, ethylene-glycol, 1,4-butanediol (BDO), 1,6-hexane diol (HDO), N,N-diethanolamine and N,N-diisopropanolaniline.

BDO and HDO being particularly preferred.

In a preferred embodiment, the sum of blocks deriving from monomers (c) and (d) is from 10 to 60 wt. % based on the total weight of the F-TPU polymer.

Those skilled in the art would readily understand that blocks comprising recurring units derived from monomers (a) and (b) are rubber-like blocks, while blocks comprising recurring units derived from monomers (c) and (d) are hard blocks.

In a preferred embodiment, at least 80% of the blocks comprising recurring units derived from said monomers (b) [blocks B] are linked, at least one of their ends, to a block comprising recurring units derived from monomers (a) [blocks A] through a block comprising recurring units derived from monomers (c) [blocks C].

In other words, at least 80% of blocks B are contained in a sequence of the following type: -[A-C—B-C]-.

Advantageously, the F-TPU polymer can be prepared following the procedures disclosed in U.S. Pat. No. 5,332,798 (AUSIMONT S.P.A.), in particular in Example 15.

According to a preferred embodiment, the watch band is made from a composition (C) that is free of plasticizer agents.

Preferably, said composition (C) comprises the F-TPU polymer as defined above as the main component.

More preferably, said F-TPU polymer is in an amount of at least 60 wt. %, more preferably at least 80 wt. %, even more preferably at least 85 wt. % based on the total weight of said composition (C).

In addition to the F-TPU polymer, said composition (C) can optionally comprise further additives, such as for example antioxidants, thermal stabilizers, dyestuffs and fillers.

Embodiments wherein said composition (C) is essentially made of said F-TPU polymer in combination with an amount of up to 1 wt. % of any of the additives listed above are also encompassed by the present invention.

The watch band according to the present invention is sufficiently stretchable and resilient such that even when stretched, for example over the wrist or other parts of the body of a user, it returns towards its original shape and is held in place on the wrist by tension, without requiring a clasp, buckle or other dedicated attachment device.

Most commonly, the watch band according to the present invention is made such that it can be worn around the wrist of a user, but it can be suitable also for wearing around other parts of the body of the user, such as the neck, finger or head.

The watch band according to the present invention can be made following methods known in the art.

As an example, the watch band can be manufactured by a process comprising the following steps:
(i) providing a mould;
(ii) filling said mould with a composition comprising at least one elastomeric fluorinated polyurethane [F-TPU polymer] as defined above;
(iii) sealing the mould;
(iv) heat treating the sealed mould; and
(v) extracting the watch band from the mould.

Preferably, said mould is in the shape of a band. Any suitable size, shape and form of the mould can be used, dependent on the desired size, shape and form of the band to be produced.

Preferably, step (iv) comprises two steps, wherein the first step comprises heating at a first temperature for a time from 10 seconds to 10 minutes and the second step comprises heating at a second temperature, said second temperature being lower than said first temperature, for a time of from 30 seconds to 24 hours.

More preferably, said first temperature is from 120° C. to 300° C.

More preferably, said second temperature is from 50° C. to 200° C.

Alternatively, step (iv) comprises only one step of heating at a temperature of from 50° C. to 300° C. for a time of from 10 seconds to 24 hours.

Preferably, after step (iv) and before step (v), the mould is allowed to cool down.

Should the disclosure of any patents, patent applications and publications which are incorporated herein by reference conflict with the description of the present application to the extent that it may render a term unclear, the present description shall take precedence.

The invention will be herein after illustrated in greater detail by means of the Examples contained in the following Experimental Section; the Examples are merely illustrative and are by no means to be interpreted as limiting the scope of the invention.

### EXPERIMENTAL SECTION

Materials

### Monomers (a):

(a1) polycaprolactonediol (PLC) having molecular weight (Mw) of about 2,000
(a2) polytetramethyleneglycol (PTMEG) having Mw of about 2,000
(a3) polycarbonate-diol (PCD) having Mw of about 2,000
(a4) polyester-diol having Mw of about 2,000
   Monomers (b) having formula:

H(OCH₂CH₂)ₚOCH₂CF₂O(CF₂CF₂O)ₘ(CF₂O)ₙCF₂CH₂O(CH₂CH₂O)ₚH
(b1) p=4.7 and Mw of about 2,000
(b2) p=1.6 and Mw of about 1,700

### Monomers (c):

(c1) diphenylen-4,4′-diisocyanate (MDI)
(c2) 1,6-hexan-diisocyanate

### Monomers (d):

(d1) 1,4-butanediol (BDO)
(d2) 1,6-hexandiol (HDO)

### Catalyst:

bismuth neodecanoate

Preparation of F-TPU Polymer Specimens—Method A

F-TPU polymer specimens in the form of sheet were prepared starting from the abovementioned monomers following the same procedure detailed in Example 15 of U.S. Pat. No. 5,332,798 (to Ausimont S.p.A.) cited above.

F-TPU polymers thus obtained contained 20 wt. % of recurring units derived from monomers (b).

Preparation of F-TPU Polymer Specimens—Method B

F-TPU polymer specimens 5 to 7 and 8 (the latter as comparison) in the form of sheet were prepared as follows:
the hydrogenated pre-polymer was synthesized by reacting monomer (c) and monomer (a) in the equivalent ratio 2 to 1, at a temperature of 90° C.;
the fluorinated pre-polymer was synthesized by reacting monomer (c) and monomer (b) in the equivalent ratio 2 to 1, at a temperature of 90° C.;
the hydrogenated pre-polymer and the fluorinated pre-polymer were then mixed together and stirred at 90° C. for 30 minutes;
monomer (c) was further added depending on the selected stoichiometry;
the reaction was continued at 90° C. for 3 minutes until chain-extension was completed;
the polymer thus obtained was casted at 100° C. for 24 hours.

The compositions of the F-TPU polymers obtained following methods A and B described above and the compositions of comparative hydrogenated polyurethane polymers (H-TPU) are reported in the following Table 1.

As further comparison, a commercially available hydrogenated TPU (H-TPU 9*) was used. The monomers ratio for H-TPU 9* is not publicly available.

TABLE 1

| | Monomers (ratio by mol) | | | | | | | | | |
|---|---|---|---|---|---|---|---|---|---|---|
| | a1 | a2 | a3 | a4 | b1 | b2 | c1 | c2 | d1 | d2 |
| F-TPU 1 | 0.8 | — | — | — | 0.2 | — | 2.0 | — | 1.0 | — |
| F-TPU 2 | — | 0.7 | — | — | 0.3 | — | 3.0 | — | 2.0 | — |
| F-TPU 3 | — | 0.6 | — | — | — | 0.4 | 2.5 | — | 1.5 | — |
| F-TPU 4 | — | — | — | 0.75 | 0.25 | — | — | 2.0 | — | 1.0 |
| F-TPU 5 | 0.75 | — | — | — | — | 0.25 | — | 3.0 | 2.0 | — |
| F-TPU 6 | — | — | 0.75 | — | — | 0.25 | — | 2.0 | 1.0 | — |
| F-TPU 7 | 4.0 | — | — | — | — | 0.3 | — | 0.7 | 3.0 | — |
| H-TPU | — | 1.0 | — | — | — | — | 2.0 | — | 1.0 | — |
| 8(*) | | | | | | | | | | |
| H-TPU | n/a | — | — | — | — | — | — | n/a | n/a | — |
| 9(*) | | | | | | | | | | |

(*)comparison
n/a = value not available

The mechanical properties of sheets made from F-TPU and H-TPU polymers were evaluated and the results are reported in Table 2.

TABLE 2

| | | Tensile | Elongation at |
|---|---|---|---|
| | Shore A | strength (MPa) | break (%) |
| F-TPU 1 | 85 | 28.1 | 471 |
| F-TPU 2 | 93 | 31 | 410 |
| F-TPU 3 | 80 | 35 | 400 |
| F-TPU 4 | 75 | 7.30 | 590 |
| F-TPU 5 | 90 | 26.1 | 505 |
| F-TPU 6 | 83 | 13 | 550 |
| F-TPU 7 | 91 | 31.8 | 506 |
| H-TPU 8(*) | 78 | 40 | 550 |

(*)comparison

The above results show that the F-TPU polymers according to the present invention have mechanical properties comparable with the mechanical properties of H-TPU polymers typically used in the production of the upper of footwear articles, and hence F-TPU polymers provide good mechanical properties to the finished upper.

The sheets were used in the Examples described hereinafter.

### Example 1—Contact Angle

This test is considered to be predictive for both stain and chemical resistance.

The static contact angle (SCA) of a sessile drop (about 5 μL) of water and n-hexadecane as solvents was measured with the DSA30 instrument (Krüss GmbH, Germany). The SCA values as well as standard deviations were calculated among ten contact angles.

Surface free energy was calculated following the Owens, Wendt, Rabel and Kaelble method (WORK method), which is a standard method for calculating the surface free energy of a solid from the contact angle with several liquids.

The results are summarized in the following Table 3.

TABLE 3

| Sample | SCA H₂O | SCA C₁₆ | SFE (mN/m) |
|---|---|---|---|
| F-TPU 1 | 104 | 64.5 | 16.1 |
| F-TPU 2 | 110.5 | 63.6 | 15.09 |
| F-TPU 3 | 106.7 | 62.9 | 15.90 |
| F-TPU 4 | 86 | 61 | 23.6 |
| F-TPU 5 | 105 | 68 | 14.9 |
| F-TPU 6 | 103 | 66 | 16 |
| F-TPU 7 | 98 | 70 | 16.9 |
| H-TPU 8(*) | 77 | 46 | 30.93 |
| H-TPU 9(*) | 81 | 29 | 31.7 |

(*)comparison
SCA = Static Contact Angle
H₂O = water
C₁₆ = hexadecane
SFE = Surface Free Energy

The above results show that the contact angle measured with both water (H₂O) and hexadecane (C₁₆) increased while the surface energy dropped down to the range from 15 to 16 mN/m compared to 31 mN/m for the hydrogenated thermoplastic polyurethane used as reference compound. These data are consistent with an increase in terms of stain resistance and chemical resistance conferred by the F-TPUs compared to H-TPU.

### Example 2—Blue Denim Test

This test is considered to be predictive for both staining and abrasion resistance.

The test was performed with the instrument Taber Industries 5750 Linear Abraser, that was set to run at the following conditions:
cycle speed: 30 cycles/min
stroke length: 2.54 cm (1 inch)
number of cycles: 200
total load: 1 kg.

Tests were performed once with dry denim and once with wet denim on F-TPU 1, F-TPU 2, F-TPU 3, F-TPU 5 and F-TPU 7.

Before performing the test with wet denim, denim was submerged in water for 10 second, then it was removed and water was squeezed out by hand so that denim did not drip but was wet to the touch.

The tests were performed as follows: a denim sample measuring approximately 30 mm×30 mm was fixed to a fixture in order to prevent shifting of the sample during the test. A sample of each F-TPU and of H-TPU was then placed on the denim sample and fixed to the fixture as well.

Checkpoints were set as follows:
after rub and
after cleaning with isopropyl-alcohol (IPA).

Results for the dry test: no stain was observed for F-TPU 1, F-TPU 2, F-TPU 3, F-TPU 5 and F-TPU 7.

Results for the wet test: a very light halo was observed for F-TPU 1, F-TPU 2, F-TPU 3, F-TPU 5 and F-TPU 7.

### Example 3—Stain Test

A drop of each staining agent listed above was put into contact with the surface of a specimen made from F-TPU 1 and let for 24 hours at ambient conditions. The specimen was then cleaned with water.

A specimen made from H-TPU was used as comparison and treated as disclosed above.

The results are summarized in the following Table 4, wherein:
++=no stain
+=mark/halo
=stain

TABLE 4

| Staining agent | H-TPU(*) | F-TPU |
|---|---|---|
| Olive oil | − | ++ |
| Ketchup | + | ++ |
| Hot coffee | − | + |
| Mayonaise | − | ++ |
| Coca Cola | − | ++ |
| Mustard | − | + |
| Vinager | ++ | ++ |
| Windex ® cleaner | + | + |
| Formula 409 ® cleaner | + | + |
| Purell ® hand sanitizer | − | ++ |
| Vaseline intensive care lotion | − | ++ |
| Alcohol | − | ++ |

(*)comparison

The above results clearly showed the increase in term of both stain and chemical resistance of the F-TPU specimen compared to the H-TPU specimen.

### Example 4—Evaluation of Haptic Properties

The haptic properties (notably the feeling of softness) of F-TPUs and H-TPUs were measured by testing the sheets of the materials subjectively by hand feel of 5 individuals.

Soft feel was measured subjectively by hand touch and rated on a scale from 1 to 5, with 1 being poor soft feel (hard feel) and 5 being excellent soft feel. Participants took part in this study individually, so they did not influence each other in their responses. Participants were presented with the four samples in a random order and asked to feel and rate them.

The results are summarized in the following Table 5.

TABLE 5

| | Rating | | | | | |
|---|---|---|---|---|---|---|
| | Indi- | Indi- | Indi- | Indi- | Indi- | |
| | vidual | vidual | vidual | vidual | vidual | |
| Sample | 1 | 2 | 3 | 4 | 5 | Average |
| F-TPU 1 | 4 | 5 | 4 | 4 | 5 | 4.4 |
| F-TPU 2 | 5 | 5 | 5 | 4 | 5 | 4.8 |
| F-TPU 3 | 5 | 4 | 4 | 4 | 4 | 4.2 |
| F-TPU 4 | 5 | 5 | 5 | 4 | 5 | 4.8 |
| F-TPU 5 | 5 | 4 | 4 | 3 | 4 | 4.0 |
| F-TPU 6 | 5 | 4 | 5 | 4 | 4 | 4.4 |
| F-TPU 7 | 4 | 4 | 4 | 4 | 5 | 4.2 |
| H-TPU | 2 | 1 | 1 | 1 | 2 | 1.4 |
| 8(*) | | | | | | |
| H-TPU | 2 | 2 | 1 | 1 | 2 | 1.6 |
| 9(*) | | | | | | |

(*)comparison

The above results clearly showed that the sheets obtained with the F-TPUs according to the present invention showed better haptic properties, notably improved feeling of softness, when compared to sheets obtained from H-TPU polymer.

1. A watch band made from a composition (C), said composition (C) comprising at least one fluorinated polyurethane [F-TPU polymer], said F-TPU polymer comprising recurring units derived from:
(a) at least one diol selected from poly-ether type diols, poly-ester type diols, polybutadien-diols and polycarbonate-diols;
(b) at least one hydroxy-terminated (per)fluoropolyether polymer [PFPE polymer];
(c) at least one aromatic, aliphatic or cycloaliphatic diisocyanate; and
(d) at least one aliphatic, cycloaliphatic or aromatic diol having from 1 to 14 carbon atoms.

2. The watch band according to claim 1, wherein (a) is selected from poly(ethylene)glycol, poly(propylene)glycol, poly(tetramethylene)glycol (PTMG), poly(1,4-butanediol)adipate, poly(ethandiol-1,4-butanedio) adipate, poly(1,6-hexandiol-neopentyl)glycol adipate, poly-caprolactone-diol (PCL) and polycarbonate-diol.

3. The watch band according to claim 1, wherein (b) is a hydroxy-terminated (per)fluoropolyether polymer [PFPE polymer] comprising a (per)fluoropolyoxyalkylene chain (R_{pf}) having two chain ends, wherein one or both chain ends terminate with at least one —OH group.

4. The watch band according to claim 3, wherein at least one chain end of said chain (R_{pf}) terminates with a group of formula:
—CH₂(OCH₂CH₂)ₜOH (I)
wherein
t is 0 or from 1 to 5.

5. The watch band according to claim 4, wherein both chain ends of said chain (Rₚf) terminate with a group of formula:
—CH₂(OCH₂CH₂)ₜOH (I)
wherein
t is 0 or from 1 to 5.

6. The watch band according to claim 3, wherein chain (R_{pf}) is a chain of formula
—(CFX)ₕO(R_{f})(CFX′)ᵢ—
wherein
h and i, equal or different from each other, are equal to or higher than 1;
X and X′, equal or different from each other, are —F or —CF₃, provided that when h and/or i are higher than 1, X and X′ are —F;
(R_{f}) comprises repeating units R^{º}, said repeating units being independently selected from the group consisting of:
(i) —CFXO—, wherein X is F or CF₃;
(ii) —CFXCFXO—, wherein X, equal or different at each occurrence, is F or CF₃, with the proviso that at least one of X is —F;
(iii) —CF₂CF₂CW₂O—, wherein each of W, equal or different from each other, are F, Cl, H;
(iv) —CF₂CF₂CF₂CF₂O—; and
(v) —(CF₂)ⱼ—CFZ—O— wherein j is an integer from 0 to 3 and Z is a group of general formula —O—R_{(f-a)}-T, wherein R_{(f-a)} is a fluoropolyoxyalkene chain comprising a number of repeating units from 0 to 10, said recurring units being selected from: —CFXO—, —CF₂CFXO—, —CF₂CF₂CF₂O—, —CF₂CF₂CF₂CF₂O—, with each of each of X being independently F or CF₃ and T being a C₁-C₃ perfluoroalkyl group.

7. The watch band according to claim 6, wherein said chain (R_{f}) is a chain selected from chains of formulae (R_{f}-a) to (R_{f}-c):
—(CF₂O)ₙ(CF₂CF₂O)ₘ(CF₂CF₂CF₂O)ₚ(CF₂CF₂CF₂CF₂O)_{q}— (R_{f}-a)
wherein m, n, p, q are 0 or integers selected in such a way that chain R_{f} meets the above number average molecular weight requirement, with the proviso that if p and q are simultaneously 0, n is not 0;
—(CF₂CF(CF₃)O)ₐ(CF₂CF₂O)_{b}(CF₂O)_{c}(CF(CF₃)O)_{d}— (R_{f}-b)
wherein a, b, c, d are 0 or integers selected in such a way that chain R_{f} meets the above number average molecular weight requirement; with the proviso that at least one of a, c and d is not 0;
—(CF₂CF(CF₃)O)ₑ(CF₂O)_{f}(CF(CF₃)O)_{g}— (R_{f}-c)
wherein e, f, g are 0 or integers selected in such a way that chain R_{f} meets the above number average molecular weight requirement.

8. The watch band according to claim 1, wherein said PFPE polymer complies with the following formula (PFPE-I):
HO—(CH₂CH₂O)ₜ—CH₂—(R_{pf})—CH₂(OCH₂CH₂)ᵤ—OH (PFPE-I)
wherein
t and u, each independently, are 0 or from 1 to 5 and
R_{pf} is a chain of formula:
—(CFX)ₕO(R_{f})(CFX′)ᵢ—
wherein
h and i, equal or different from each other, are equal to or higher than 1,
X and X′, equal or different from each other, are —F or —CF₃, provided that when h and/or i are higher than 1, X and X′ are —F,
(R_{f}) comprises repeating units R^{º}, said repeating units being independently selected from the group consisting of:
(i) —CFXO—, wherein X is F or CF₃;
(ii) —CFXCFXO—, wherein X, equal or different at each occurrence, is F or CF₃, with the proviso that at least one of X is —F,
(iii) —CF₂CF₂CW₂O—, wherein each of W, equal or different from each other, are F, Cl, H;
(iv) —CF₂CF₂CF₂CF₂O—; and
(v) —(CF₂)ⱼ—CFZ—O— wherein j is an integer from 0 to 3 and Z is a group of general formula —O—R_{(f-a)}-T, wherein R_{(f-a)} is a fluoropolyoxyalkene chain comprising a number of repeating units from 0 to 10, said recurring units being selected from: —CFXO—, —CF₂CFXO—, —CF₂CF₂CF₂O—, —CF₂CF₂CF₂CF₂O—, with each of each of X being independently F or CF₃ and T being a C₁-C₃ perfluoroalkyl group.

9. The watch band according to claim 1, wherein (c) is selected from 4,4′-methylene-diphenylene-di-isocyanate (MDI), 2,4-toluene-diisocyanate, 2,6-toluene-diisocyanate, xylilen-diisocyanate, naphthalene-diisocyanate, paraphenylen-diisocyanate, hexamaethylen-diisocyanate, isophorone-diisocyanate, 4,4′-dicyclohexyl-methane-diisocyanate and cyclohexyl-1,4-diisocyanate.

10. The watch band according to claim 1, wherein (d) is selected from ethylene-glycol, 1,4-butanediol (BDO), 1,6-hexane diol, N,N-diethanolamine and N,N-diisopropanolaniline.

11. The watch band according to claim 1, wherein at least 80% of the blocks comprising recurring units derived from (b) are linked, at least one of their ends, to a block comprising recurring units derived from (a) through a block comprising recurring units derived from (c).

12. The watch band according to claim 1, wherein said composition (C) is free of plasticizer agents.

13. The watch band according to claim 1, wherein said composition (C) comprises said F-TPU polymer as the main component.

14. The watch band according to claim 13, wherein said F-TPU polymer is in an amount of at least 60 wt. % based on the total weight of said composition (C).

15. A process for manufacturing a watch band, said process comprising:
filling a mould with a composition comprising at least one elastomeric fluorinated polyurethane [F-TPU polymer] according to claim 1;
sealing the mould;
heat treating the sealed mould; and
extracting the watch band from the mould.

16. The watch band according to claim 7, wherein chain (R_{f}) is a chain selected from chains of formula (R_{f}-a) and wherein, when m is other than 0, the m/n ratio is between 0.1 and 20; when (m+n) is other than 0, (p+q)/(m+n) is between 0 and 0.2.

17. The watch band according to claim 7, wherein chain (R_{f}) is a chain selected from chains of formula (R_{f}-b) and wherein, when b is other than 0, a/b is between 0.1 and 10; when (a+b) is different from 0, (c+d)/(a+b) is between 0.01 and 0.5.

18. The watch band according to claim 7, wherein chain (R_{f}) is a chain selected from chains of formula (R_{f}-c) and wherein, when e is other than 0, (f+g)/e is between 0.01 and 0.5.

19. The watch band according to claim 1, wherein
(a) is selected from poly(ethylene)glycol, poly(propylene)glycol, poly(tetramethylene)glycol (PTMG), poly(1,4-butanediol)adipate, poly(ethandiol-1,4-butanedio) adipate, poly(1,6-hexandiol-neopentyl)glycol adipate, poly-caprolactone-diol (PCL) and polycarbonate-diol;
(b) is a hydroxy-terminated (per)fluoropolyether polymer [PFPE polymer] comprising a (per)fluoropolyoxyalkylene chain (R_{pf}) having two chain ends, wherein one or both chain ends terminate with at least one —OH group;
(c) is selected from 4,4′-methylene-diphenylene-di-isocyanate (MDI), 2,4-toluene-diisocyanate, 2,6-toluene-diisocyanate, xylilen-diisocyanate, naphthalene-diisocyanate, paraphenylen-diisocyanate, hexamaethylen-diisocyanate, isophorone-diisocyanate, 4,4′-dicyclohexyl-methane-diisocyanate and cyclohexyl-1,4-diisocyanate; and
(d) is selected from ethylene-glycol, 1,4-butanediol (BDO), 1,6-hexane diol, N,N-diethanolamine and N,N-diisopropanolaniline.
